(19) United States
(12) Patent Application Publication
(10) Pub. No.: US 2024/0012616 A1
(43) Pub. Date: Jan. 11, 2024

(54) PROGRAMMABLE FINITE FIELD GENERATOR FOR MEMORY

(71) Applicant: Micron Technology, Inc., Boise, ID (US)

(72) Inventor: Keith A. Benjamin, East Bethel, MN (US)

(21) Appl. No.: 17/811,846

(22) Filed: Jul. 11, 2022

(51) Int. Cl. G06F 7/544

(52) U.S. Cl. CPC G06F 7/5443; G06F 2207/581

(57) ABSTRACT

Methods, systems, and devices for a programmable finite field generator for memory are described. In some cases, a system (e.g., a memory system, a host system) may store coefficient values indicating Galois Field multipliers in an array of configuration registers associated with a finite field generator. To update a set of values stored in a set of registers associated with the finite field generator, the system may perform a set of Galois Field multiplication operations according to Galois Field multipliers indicated by the coefficient values stored in the array of configuration registers. The system may perform at least one Galois Field summation operation on one or more of the multiplied values to generate an updated value. Then, the system may store the updated value in a first register from the set of registers, and shift the set of values along the remaining set of registers.

### FIELD OF TECHNOLOGY

The following relates to one or more systems for memory, including a programmable finite field generator for memory.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports a programmable finite field generator for memory in accordance with examples as disclosed herein.

FIG. 2 illustrates an example of sequence generation circuitry that supports a programmable finite field generator for memory in accordance with examples as disclosed herein.

FIG. 3 illustrates an example of a sequence generator that supports a programmable finite field generator for memory in accordance with examples as disclosed herein.

FIG. 4 shows a block diagram of a memory system that supports a programmable finite field generator for memory in accordance with examples as disclosed herein.

FIG. 5 shows a flowchart illustrating a method or methods that support a programmable finite field generator for memory in accordance with examples as disclosed herein.

### DETAILED DESCRIPTION

Some systems, such as memory systems or host systems, may generate substantially random binary sequences to perform various operations. For example, a system (e.g., a memory system, a host system) may rely on substantially random binary sequences to perform cryptographic operations such as encrypting or decrypting data stored at or received by the system. In another example, the system may rely on substantially random binary sequences as a noise source for communication channels (e.g., between systems, devices, components, other elements, any combination). Additionally, the system may include hardware or circuitry to generate substantially random binary sequences (e.g., finite field generator circuitry). In some cases, a configuration of the circuitry may result in corresponding features of the binary sequence generation at the system. For example, the configuration of the circuitry may yield a corresponding bitrate for the binary sequence generation, a corresponding power consumption of the circuitry when generating binary sequences, and a corresponding quantity of binary sequences being generated in parallel by the circuitry. But in some cases, the system may perform operations or procedures that use varying quantities substantially random binary sequences or varying bitrates of substantially random binary sequences, which may not be supported by the hardware or circuitry generating the substantially random binary sequences at the system because the hardware or circuitry may be statically configured.

The techniques as described herein provide for a system to include circuitry for generating substantially random binary sequences that is programmable, which may enable the system to adjust parameters such as a bitrate associated with the sequence generation, a quantity of sequences generated in parallel, or a power consumption associated with the bit generation, or other aspects, or any combination thereof. In some cases, the programmable sequence generator (e.g., a programmable finite field generator) may include an array of configuration registers and the system may store different values in the configuration registers to program and reprogram the sequence generator. For example, the system may generate a substantially random binary sequence by outputting values stored in a first register of a set of registers associated with the finite field generator. Here, the system may store coefficient values indicating Galois Field (GF) multipliers in the array of configuration registers. To set or otherwise update a set of values stored in the set of registers associated with the finite field generator, the system may perform a set of GF multiplication operations according to GF multipliers indicated by, for example, the coefficient values stored in the array of configuration registers. Additionally, the system may perform at least one GF summation operation on one or more of the multiplied values to generate an updated value. Then, the system may store the updated value in the first register (e.g., and output the stored value as part of a substantially random binary sequence), and shift the set of values along the remaining set of registers.

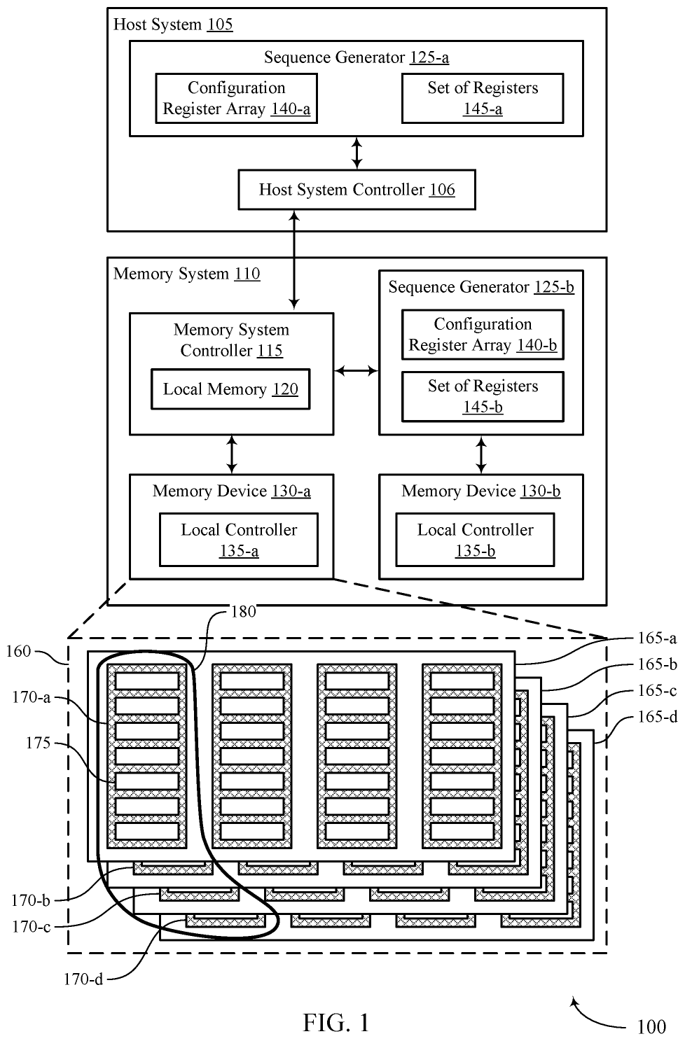

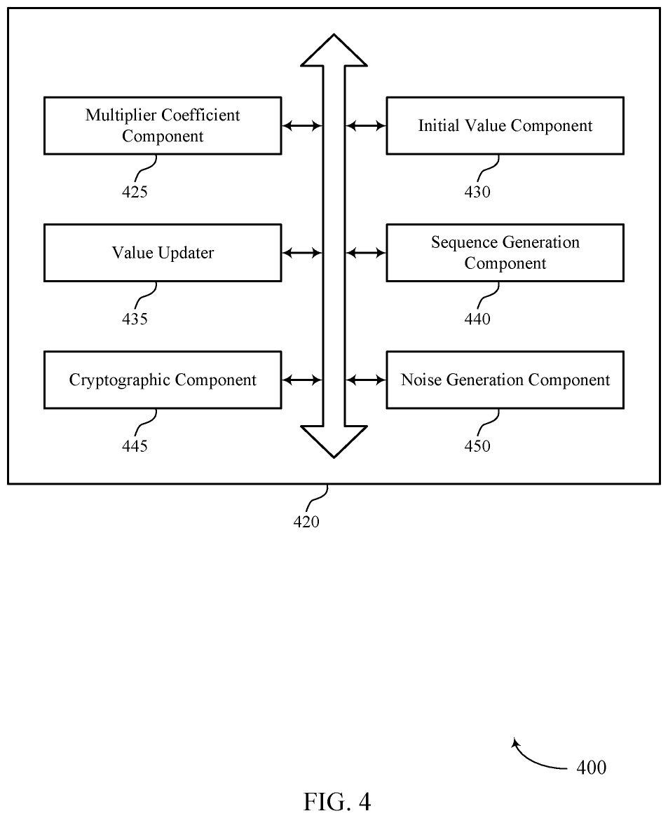

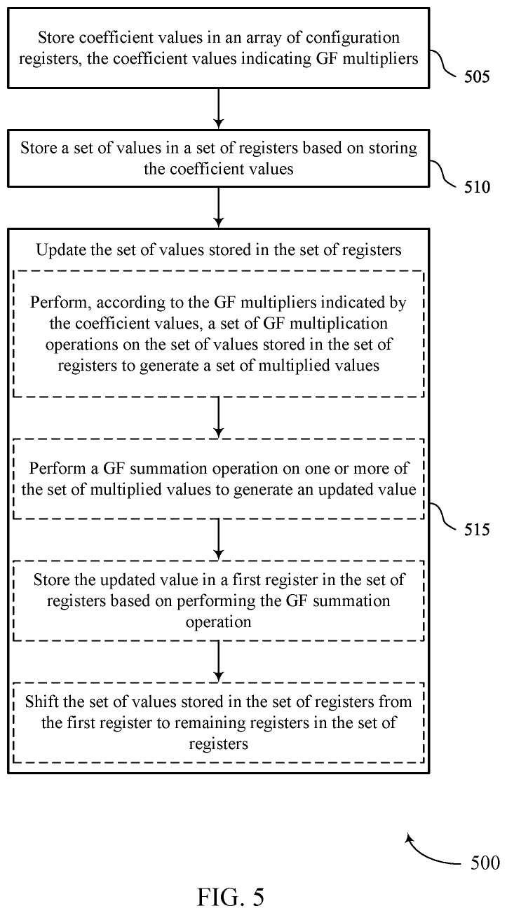

Features of the disclosure are initially described in the context of systems, sequence generation circuitry, and sequence generator with reference to FIGS. 1 through 3. These and other features of the disclosure are further illustrated by and described in the context of an apparatus diagram and flowchart that relate to a programmable finite field generator for memory with reference to FIGS. 4 and 5.

FIG. 1 illustrates an example of a system 100 that supports a programmable finite field generator for memory in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MHLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Some host systems 105 or memory systems 110 or both may generate substantially random binary sequences to perform various operations. For example, the host system 105 or the memory system 110 may rely on substantially random binary sequences to perform cryptographic operations such as encrypting or decrypting data stored at or received by the system. For example, the host system 105 or the memory system 110 may generate seed sequence for encrypting or decrypting data based on a substantially random binary sequence. Then, the host system 105 or the memory system 110 may encrypt data prior to storing the data (e.g., at a memory device 130) or prior to communicating the data between the host system 105 and the memory system 110 (or another device). Additionally, or alternatively, the host system 105 or the memory system 110 may use a seed sequence to decrypt data (e.g., stored at the host system 105 or the memory system 110, communicated between the host system 105 and the memory system 110).

In another example, the host system 105 or the memory system 110 may rely on substantially random binary sequences as a broad spectrum noise source for transmitting signaling between the host system 105 and the memory system 110. For example, the host system 105 or the memory system 110 may use a substantially random binary sequence as a known broad spectrum noise source, and may inject the known broad spectrum noise source into a signal for communications between the host system 105 and the memory system 110. Then, the receiving system (e.g., the host system 105 or the memory system 110) may remove the known broad spectrum noise source (e.g., that is based on the substantially random binary sequence) from the signal. Additionally, or alternatively, the host system 105 or the memory system 110 may use the broad spectrum noise source to enable more accurate signal measurements (e.g., via dithering).

To generate substantially random binary sequences, the host system 105 and the memory system 110 may include hardware or circuitry associated with a sequence generator 125. In some cases, a configuration of the circuitry and other hardware of the sequence generator 125 may result in corresponding features of the binary sequence generation at the system. For example, each sequence generator 125 may generate a finite field sequence that is constrained by finite field arithmetic units implemented by the circuitry and other hardware. Additionally, each sequence generator 125 may generate a finite field sequence that is constrained to an order (e.g., a polynomial order) implemented by the circuitry and other hardware of the sequence generator 125. Additionally, or alternatively, the sequence generators 125 may generate a sequence type that is a characteristic of the circuitry and other hardware included in the sequence generator 125 (e.g., a GF(2) sequence).

In another example, the configuration of the circuitry associated with the sequence generator 125 may yield a corresponding bitrate for the binary sequence generation, a corresponding power consumption of the circuitry when generating binary sequences, and a corresponding quantity of binary sequences being generated in parallel by the circuitry. But in some cases, the host system 105 or the memory system 110 may perform operations or procedures that use varying quantities substantially random binary sequences or varying bitrates of substantially random binary sequences, which may not be supported by the hardware or circuitry generating the substantially random binary sequences at the host system 105 or the memory system 110 due to the hardware or circuitry being statically configured. In some cases, a host system 105 or a memory system 110 may include multiple sequence generators 125, each configured to generate sequences associated with specific features. For example, a host system 105 or a memory system 110 may include a first sequence generator 125 for generating substantially random binary sequences corresponding to a fourth order polynomial and a second sequence generator 125 for generating substantially random binary sequences corresponding to an eighth order polynomial. However, multiple sequence generators 125 may span a larger area of a die or substrate on the memory system 110 or the host system 105 as compared to a system with a single sequence generator 125.

In the example of the system 100, the host system 105 and the memory system 110 may include sequence generators 125 that are programmable, which may enable the host system 105 and the memory system 110 to adjust parameters such as a bitrate associated with the sequence generation, a quantity of sequences generated in parallel, or a power consumption associated with the bit generation. Additionally, the host system 105 and the memory system 110 may program the sequence generators 125 to generate substantially random binary sequences (e.g., finite field sequences) associated with different polynomial orders and types. For example, the host system 105 or the memory system 110 may program the sequence generator 125 to output sequences in GF(2) or GFs with different characteristics (e.g., GF(4)).

In some cases, the programmable sequence generators 125 (e.g., a programmable finite field generator) may each include a configuration register array 140 and the host system 105 and the memory system 110 may store different values in each register of the configuration register arrays 140 to program and reprogram the sequence generator 125. For example, the host system 105 may store different values in the configuration register array 140-a to program the sequence generator 125-a and the memory system 110 may store different values in the configuration register array 140-b to program the sequence generator 125-b.

To generate a substantially random binary sequence, the host system 105 and the memory system 110 may output values stored in a first register of the set of registers 145. For example, the host system 105 and the memory system 110 may store coefficient values indicating GF multipliers in the configuration register array 140. To update the values stored by each of the set of registers 145, the host system 105 and the memory system 110 may perform a set of GF multiplication operations according to GF multipliers indicated by the coefficient values stored in the configuration register array 140. Additionally, the host system 105 or the memory system 110 may perform at least one GF summation operation on one or more of the multiplied values to generate an updated value. Then, the host system 105 or the memory system 110 may store the updated value in the first register (e.g., and output the stored value as part of a substantially random binary sequence) and shift the set of values along the remaining registers in the set of registers 145.

The sequence generators 125 may be examples of general finite field generators, which may implement summation and multiplication operations that conform to GF arithmetic. In some cases, the sequence generators 125 may include features similar to a linear feedback shift register (LFSR), but may include the circuitry to implement GF summation and multiplication operations (e.g., which general LFSRs may not include).

The system 100 may include any quantity of non-transitory computer readable media that support programmable finite field generator for memory. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

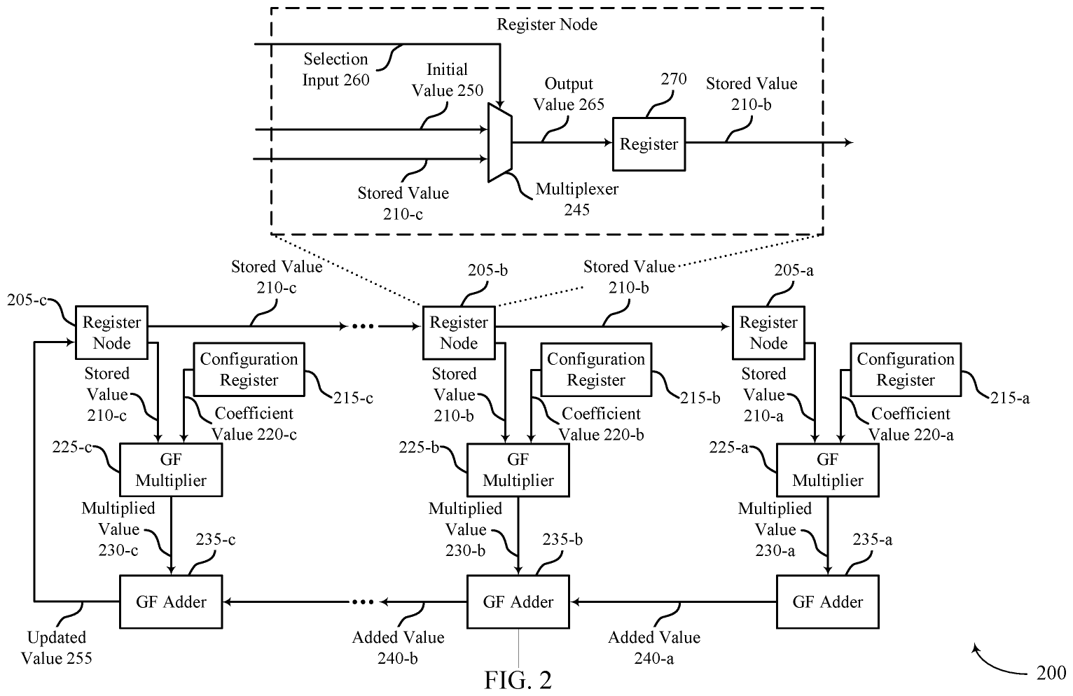

FIG. 2 illustrates an example of a sequence generation circuitry 200 that supports a programmable finite field generator for memory in accordance with examples as disclosed herein. For example, the sequence generation circuitry 200 may be an example of the sequence generator as described with reference to FIG. 1. Additionally, the sequence generation circuitry 200 may include an array of configuration registers 215 and a set of register nodes 205, which may include aspects of the configuration register arrays and the set of registers, respectively, as described with reference to FIG. 1. In some cases, a memory system or a host system, as described herein, may include the sequence generation circuitry 200 to generate substantially random binary sequences.

To configure or program the sequence generation circuitry 200, a system may store various coefficient values 220, which may indicate corresponding GF multipliers for the sequence generation circuitry 200. That is, the system may dynamically adjust an operation of the sequence generation circuitry 200 by storing different coefficient values 220 in the array of configuration registers 215. In some cases, the system may set (e.g., initially, update) the coefficient values 220 to adjust an order of the finite field sequence generated by the sequence generation circuitry 200. Additionally, or alternatively, the system may set (e.g., initially, update) the coefficient values 220 to correspond with adjusted bitrates of finite field sequence generation of the sequence generation circuitry 200. For example, in cases that the system increases a quantity of bits generated (e.g., associated with an increased bitrate), the system may additionally adjust the coefficient values 220 (e.g., by updating the coefficient values 220 from being associated with a GF(2) sequence to being associated with a GF(4) sequence).

Additionally, or alternatively, in cases that the system decreases the bitrate of the finite field sequence generation of the sequence generation circuitry 200, the system may additionally adjust the coefficient values 220 (e.g., by updating the coefficient values 220 from being associated with a GF(4) sequence to being associated with a GF(2) sequence). Similarly, the system may adjust (e.g., increase, decrease) a power consumption of the sequence generator based on storing different coefficient values 220 in the array of configuration registers 215. That is, the system may set one or more of the coefficient values 220 to values that effectively switch off one or more circuits of the sequence generation circuitry 200. For example, the system may set a coefficient value 220 to a value that results in the stored value 210 at the corresponding register node 205 not being used to generate the sequence, which may effectively switch off circuits associated with the corresponding register node 205, thus conserving power at the sequence generation circuitry 200.

The sequence generation circuitry 200 may include a quantity of register nodes 205, which each include a multiplexer 245 (or other selection circuitry) and a register 270, which may include one or more flip-flop circuits. To store a set of initial values 250 at each register node 205, the system may transmit signaling indicative of the initial value 250 to store at each register node 205 and additionally apply, to the multiplexer 245 at each register node 205, a selection input 260 to propagate the signaling indicative of the initial value 250 through the multiplexer 245 to the output value 265. Then, the register 270 will store the initial value 250 based on the selection input 260 selecting for the output value 265 to be the initial value 250 (e.g., instead of the stored value 210-c). Thus, the system may store a set of initial values 250 in registers 270 at each of the register nodes 205.

To generate a substantially random bit sequence, the sequence generation circuitry 200 may output bits of a substantially random binary sequences (e.g., finite field sequences) from the register node 205-c. For example, a system may concatenate at least a portion of the bits stored in the register 270 of the register node 205-c (e.g., at least a portion of the bits of the stored value 210-c) over multiple cycles to obtain the substantially random binary sequence. That is, each cycle (e.g., each clock cycle, each set of a preconfigured quantity of clock cycles), the sequence generation circuitry 200 may generate an updated value 255 to store at the register node 205-c, and the substantially random binary sequence may include one or more bits from the updated value 255 over one or more cycles.

To generate the updated value 255 stored in the register node 205-c, the register nodes 205 may output the value stored in the corresponding register 270 (e.g., the stored value 210) to a GF multiplier 225. Each GF multiplier 225 may include circuitry configured to perform GF multiplication operations according to the coefficient value 220 provided to the GF multiplier 225 from a corresponding configuration register 215. Thus, each GF multiplier 225 may execute a GF multiplication operation on a received stored value 210 according to a GF multiplier indicated by a corresponding coefficient value 220-c to generate a multiplied value 230-c. For example, the register node 205-a may output the stored value 210-a to the GF multiplier 225-a, and the GF multiplier 225-a may execute a GF multiplication on the stored value 210-a according to the GF multiplier indicated by the coefficient value 220-a to generate the multiplied value 230-a.

The GF multipliers 225 may output the multiplied values 230 to a GF adder 235. For example, the GF multiplier 225-c may output the multiplied value 230-c to the GF adder 235-c. Then, the GF adders 235 may perform GF summation operations on one or more of the received multiplied values 230 to generate the updated value 255. In one example, the GF adders 235 may perform summation operations to generate the updated value 255 based on performing GF summation operations on the multiplied values 230. In another example (e.g., for a ripple adding scheme), the GF adders 235 may generate the updated value 255 based on performing GF summation operations on the multiplied values 230 and the previously-stored values 210. Although multiple GF adders 235 are illustrated in the example of the sequence generation circuitry 200, a single GF adder 235 may instead by configured to perform similar GF summation operations.

In addition to generating the updated value 255 to store at the register node 205-c, the sequence generation circuitry 200 may shift the stored values 210 between the registers 270 in each register node 205 each cycle. For example, the stored value 210-c may be shifted from being stored in a register 270 at the register node 205-b to a register 270 at a subsequent register node 205 (e.g., register node 205-b). Additionally, the stored value 210-b from the register node 205-b may be shifted from being stored in the register 270 at the register node 205-b to a register 270 at the register node 205-a. For example, the register node 205-b may receive the stored value 210-c from the register node 205-c. Then, the selection input 260 applied to the multiplexer 245 at the register node 205-b may select to propagate the stored value 210-c to the output value 265 (e.g., instead of the initial value 250) to the register 270. In some cases, the registers 270 in the register nodes 205 may synchronized across a clock boundary. That is, the registers 270 may update the stored values 210 synchronously and in response to a clock boundary (e.g., a rising clock edge, a falling clock edge, every other clock edge).

Thus, during at least some cycles if not each cycle, which may correspond to one clock cycle or multiple clock cycles (e.g., as configured by the system), the sequence generation circuitry 200 may update the stored values 210 of each register node 205. That is, the sequence generation circuitry 200 may perform GF multiplication and summation operations to generate the updated value 255 to store at the register node 205-c each cycle. Additionally, the sequence generation circuitry 200 may shift the stored values 210 along the set of registers 270 (e.g., within each register node 205) each cycle.

In some cases, the system may reconfigure the sequence generation circuitry 200 by updating the coefficient values 220 stored in the array of configuration registers 215. For example, the system may store an updated coefficient value 220 in one or multiple configuration registers. In some instances, the system may update the coefficient values 220 to indicate GF multipliers associated with a different characteristic than the previously-stored coefficient values 220 (e.g., switching between GF(2), GF(4), and GF sequences with other characteristics). Additionally, or alternatively, the system may update the coefficient values 220 to indicate GF multiplies associated with a same GF characteristic as the previously-stored coefficient values 220.

In some cases, the quantity of register nodes 205 included in the sequence generation circuitry 200 may correspond to a highest polynomial order implemented by the sequence generation circuitry 200. For example, if the highest polynomial order implemented by the sequence generation circuitry 200 is four, the sequence generation circuitry 200 may include four register nodes 205. Additionally, or alternatively, if the highest polynomial order implemented by the sequence generation circuitry 200 is eight, the sequence generation circuitry 200 may include eight register nodes 205. A system may program and reprogram the sequence generation circuitry 200 to output substantially random binary sequences corresponding polynomial orders that are less than or equal to the highest polynomial order implemented by the sequence generation circuitry 200. For example, the system may store different coefficient values 220 in the array of configuration registers 215 to effectively turn on or off circuitry associated with one or more of the register nodes 205 to adjust the polynomial order of the substantially random binary sequences generated by the sequence generation circuitry 200.

In some cases, each register 270 included in the register nodes 205 may be configured to store a quantity of bits that is based on the highest value of n supported by the sequence generation circuitry 200, where n corresponds to the characteristic GF(n) implemented by the sequence generation circuitry 200. For example, each register 270 may be configured to store at least ceiling(log₂ n) bits. A system may program and reprogram the sequence generation circuitry 200 (e.g., by storing different coefficient values 220 in the array of configuration registers 215) to output substantially random GF(n) binary sequences corresponding to various values of n that are less than or equal to the highest value of n implemented by the sequence generation circuitry 200. For example, in cases that the sequence generation circuitry 200 implements a highest value of n corresponding to the GF(16), a system may configure the sequence generation circuitry 200 to output GF(2), GF(3), GF(4), and other GF(n) sequences with values of n less than 16. Additionally, each GF multiplier 225 and GF adder 235 may be configured to support GF operations corresponding to GF orders that are less than n. For example, if the sequence generation circuitry 200 implements a highest value of n of 4, corresponding to GF(4), the GF multipliers 225 and GF adders 235 may each be capable of performing GF(0), GF(1), GF(2), GF(3), and GF(4) operations.

In some examples, the system may store coefficient values 220 in the array of configuration registers 215 to program the sequence generation circuitry 200 to generate a finite field sequence of a first (e.g., higher) order and may use the resulting finite field sequence to generate multiple finite field sequences of a second (e.g., lower) order. For example, in cases that the sequence generation circuitry 200 outputs a single GF(4) finite field sequence, a system may concatenate least significant bits of the GF(4) finite field sequence to generate one GF(2) sequence and may additionally concatenate most significant bits of the GF(4) finite field sequence to generate another GF(2) sequence in parallel. Here, a system may use each of the more than one finite field sequences generated in parallel from a higher order finite field sequence independently.

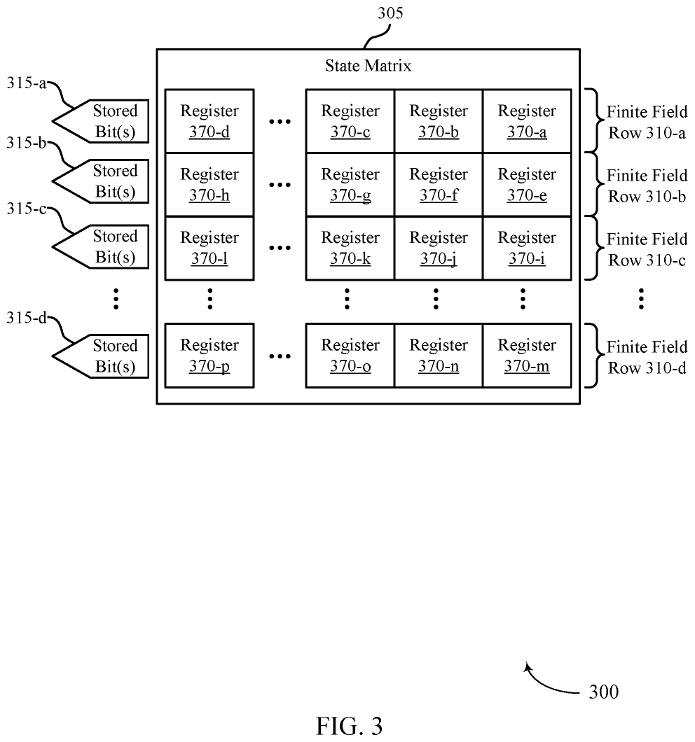

FIG. 3 illustrates an example of a sequence generator 300 that supports a programmable finite field generator for memory in accordance with examples as disclosed herein. For example, the sequence generator 300 may be examples of a sequence generator as described with reference to FIGS. 1 and 2. In some cases, the sequence generator 300 may include a state matrix 305 including a set of registers 370 that store values that are initialized, updated, and generated by sequence generation circuitry as described with reference to FIG. 2. For example, each finite field row 310-a may include the sequence generation circuitry as described with reference to FIG. 2.

The sequence generator 300 may enable a system to generate multiple finite field sequences. That is, each finite field row 310 may generate stored bits 315 corresponding to a distinct finite field sequence (e.g., using sequence generation circuitry as described with reference to FIG. 2). Thus, for each of the finite field rows 310 included in the sequence generator 300, the sequence generator 300 may generate a quantity of substantially random binary sequence. For example, if the sequence generator 300 includes four finite field rows 310, the sequence generator 300 may generate four substantially random binary sequences (e.g., comprising finite field sequences). In some cases, the sequence generator 300 may include a quantity of finite field rows 310 that corresponds to a highest polynomial order implemented by the sequence generator 300. For example, if the highest polynomial order implemented by the sequence generator 300 is four, the sequence generator 300 may include four finite field rows 310. Additionally, or alternatively, if the highest polynomial order implemented by the sequence generator 300 is eight, the sequence generator 300 may include eight finite filed rows 310.

In some cases, the width of the outputs outputting the stored bits 315 may be based on a highest polynomial order implemented by the finite field rows 310. For example, if the highest polynomial order implemented by the finite field rows 310 is four, the outputs of the sequence generator 300 (e.g., outputting the stored bits 315) may be at least four bits wide. Additionally, or alternatively, the width of the outputs outputting the stored bits 315 may be based on a maximum quantity of parallel bits q generated each cycle. For example, if the maximum quantity of parallel bits q output by the finite field rows 310 each cycle is eight, the outputs of the sequence generator 300 (e.g., outputting the stored bits 315) may be at least eight bits wide. Here, the width of the outputs outputting the stored bits 315 may correspond to the larger value between the highest polynomial order n implemented by the finite field rows 310 and the maximum quantity of parallel bits q output by the finite field rows 310.

A system may generate a substantially random binary sequence by concatenating one or more of the stored bits 315 stored in one of the registers 370 of each finite field row 310. For example, the stored bits 315-a output from the finite field row 310-a may correspond to one or more bits stored in the register 370-d. Additionally, the stored bits 315-b output from the finite field row 310-b may correspond to one or more bits stored in the register 370-h. In some cases, a finite field row 310 may generate a finite field sequence (e.g., comprising the stored bits 315) of a first (e.g., higher) order and a system may use the resulting finite field sequence to generate multiple finite field sequences of a second (e.g., lower) order. For example, in cases that the finite field row 310-c outputs a single GF(16) finite field sequence, a system may concatenate the two least significant bits from the stored bits 315-c to generate one GF(4) sequence and may additionally concatenate the two most significant bits from the stored bits 315-c to generate another GF(4) sequence in parallel. Here, a system may use each of the more than one finite field sequences generated in parallel from a higher order finite field sequence independently.

FIG. 4 shows a block diagram 400 of a system 420 (e.g., a memory system, a host system) that supports a programmable finite field generator for memory in accordance with examples as disclosed herein. The system 420 may be an example of aspects of a memory system or a host system as described with reference to FIGS. 1 through 3. The system 420, or various components thereof, may be an example of means for performing various aspects of a programmable finite field generator for memory as described herein. For example, the system 420 may include a multiplier coefficient component 425, an initial value component 430, a value updater 435, a sequence generation component 440, a cryptographic component 445, a noise generation component 450, or any combination thereof. Each of these components may communicate, directly or indirectly, with one another (e.g., via one or more buses).

The multiplier coefficient component 425 may be configured as or otherwise support a means for storing coefficient values in an array of configuration registers, the coefficient values indicating GF multipliers. The initial value component 430 may be configured as or otherwise support a means for storing a set of values in a set of registers based on storing the coefficient values. The value updater 435 may be configured as or otherwise support a means for updating the set of values stored in the set of registers. In some examples, to update the set of values, the value updater 435 may be configured as or otherwise support a means for performing, according to the GF multipliers indicated by the coefficient values, a set of GF multiplication operations on the set of values stored in the set of registers to generate a set of multiplied values, the value updater 435 may be configured as or otherwise support a means for performing a GF summation operation on one or more of the set of multiplied values to generate an updated value, the value updater 435 may be configured as or otherwise support a means for storing the updated value in a first register in the set of registers based on performing the GF summation operation, and the value updater 435 may be configured as or otherwise support a means for shifting the set of values stored in the set of registers from the first register to remaining registers in the set of registers.

In some examples, the multiplier coefficient component 425 may be configured as or otherwise support a means for storing, based on updating the set of values stored in the set of registers, second coefficient values in the array of configuration registers, where one or more of the second coefficient values are different than one or more of the coefficient values, and where the second coefficient values indicate second GF multipliers. In some examples, the value updater 435 may be configured as or otherwise support a means for updating, based on storing the second coefficient values, the set of values stored in the set of registers according to the second GF multipliers.

In some examples, the GF multipliers are associated with a first order of GF operations. In some examples, the second GF multipliers are associated with a second order of GF operations different than the first order.

In some examples, each register in the set of registers is for storing a quantity of bits. In some examples, the first order of GF operations and the second order of GF operations are less than or equal to the quantity.

In some examples, the sequence generation component 440 may be configured as or otherwise support a means for generating, based on performing one or more iterations of updating the set of values, a first sequence including a concatenation of first bits from values stored in the first register.

In some examples, the sequence generation component 440 may be configured as or otherwise support a means for outputting a second sequence including a concatenation of second bits from the values stored in the first register. That is, the sequence generation component 440 may be configured as or otherwise support a means for generating, based on performing one or more iterations of updating the set of values, the first sequence and the second sequence in parallel. For example, the sequence generation component 440 may be configured or otherwise support a means for outputting a GF(4) sequence, which may comprise the first sequence (e.g., a first GF(2) sequence) and the second sequence (e.g., a second GF(2) sequence) generated in parallel (e.g., over the one or more iterations of updating the set of values). Here, the first sequence may include the concatenation of the first bits from values stored in the first register during each of the one or more iterations. Additionally, the second sequence may include the concatenation of the second bits from the values stored in the first register during each of the same one or more iterations (e.g., the first and second sequences are generated in parallel).

In some examples, the first bits include least significant bits of the values stored in the first register during one or more iterations of updating the set of values. In some examples, the second bits include most significant bits of the values stored in the first register during one or more iterations of updating the set of values.

In some examples, the cryptographic component 445 may be configured as or otherwise support a means for generating, based on generating the first sequence, a seed sequence that is based on the first sequence. In some examples, the cryptographic component 445 may be configured as or otherwise support a means for performing, based on generating the seed sequence, a cryptographic operation using the seed sequence.

In some examples, the noise generation component 450 may be configured as or otherwise support a means for generating, based on generating the first sequence, broad spectrum noise using the first sequence.

In some examples, the first sequence includes a substantially random binary sequence.

In some examples, storing second coefficient values in a second array of configuration registers, the second coefficient values indicating second GF multipliers. In some examples, storing a second set of values in a second set of registers. In some examples, updating the second set of values stored in the second set of registers during a time interval that at least partially overlaps with updating the set of values stored in the set of registers. In some examples, to update the second set of values, the value updater 435 may be configured as or otherwise support a means for performing, according to the second GF multipliers indicated by the second coefficient values, a second set of GF multiplication operations on the second set of values stored in the second set of registers to generate a second set of multiplied values, the value updater 435 may be configured as or otherwise support a means for performing a second GF summation operation on one or more of the second set of multiplied values to generate a second updated value, the value updater 435 may be configured as or otherwise support a means for storing the second updated value in a second register in the second set of registers based on performing the second GF summation operation, and the value updater 435 may be configured as or otherwise support a means for shifting the second set of values stored in the second set of registers from the second register to remaining registers in the second set of registers.

In some examples, updating the set of values stored in the set of registers is based on a clock signal changing from a first value to a second value.

In some examples, the set of registers are associated with a finite field generator.

FIG. 5 shows a flowchart illustrating a method 500 that supports a programmable finite field generator for memory in accordance with examples as disclosed herein. The operations of method 500 may be implemented by a system (e.g., a memory system or a host system) or its components as described herein. For example, the operations of method 500 may be performed by a memory system or a host system as described with reference to FIGS. 1 through 4. In some examples, a system may execute a set of instructions to control the functional elements of the device to perform the described functions. Additionally, or alternatively, the system may perform aspects of the described functions using special-purpose hardware.

At 505, the method may include storing coefficient values in an array of configuration registers, the coefficient values indicating GF multipliers. The operations of 505 may be performed in accordance with examples as disclosed herein. In some examples, aspects of the operations of 505 may be performed by a multiplier coefficient component 425 as described with reference to FIG. 4.

At 510, the method may include storing a set of values in a set of registers based on storing the coefficient values. The operations of 510 may be performed in accordance with examples as disclosed herein. In some examples, aspects of the operations of 510 may be performed by an initial value component 430 as described with reference to FIG. 4.

At 515, the method may include updating the set of values stored in the set of registers. In some examples, updating the set of values may further include performing, according to the GF multipliers indicated by the coefficient values, a set of GF multiplication operations on the set of values stored in the set of registers to generate a set of multiplied values, performing a GF summation operation on one or more of the set of multiplied values to generate an updated value, storing the updated value in a first register in the set of registers based on performing the GF summation operation, and shifting the set of values stored in the set of registers from the first register to remaining registers in the set of registers. The operations of 515 may be performed in accordance with examples as disclosed herein. In some examples, aspects of the operations of 515 may be performed by a value updater 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing coefficient values in an array of configuration registers, the coefficient values indicating GF multipliers; storing a set of values in a set of registers based on storing the coefficient values; and updating the set of values stored in the set of registers, where updating the set of values further includes performing, according to the GF multipliers indicated by the coefficient values, a set of GF multiplication operations on the set of values stored in the set of registers to generate a set of multiplied values, performing a GF summation operation on one or more of the set of multiplied values to generate an updated value, storing the updated value in a first register in the set of registers based on performing the GF summation operation, and shifting the set of values stored in the set of registers from the first register to remaining registers in the set of registers.

Aspect 2: The method, apparatus, or non-transitory computer-readable medium of aspect 1, further including operations, features, circuitry, logic, means, or instructions, or any combination thereof for storing, based on updating the set of values stored in the set of registers, second coefficient values in the array of configuration registers, where one or more of the second coefficient values are different than one or more of the coefficient values, and where the second coefficient values indicate second GF multipliers and updating, based on storing the second coefficient values, the set of values stored in the set of registers according to the second GF multipliers.

Aspect 3: The method, apparatus, or non-transitory computer-readable medium of aspect 2, where the GF multipliers are associated with a first order of GF operations and the second GF multipliers are associated with a second order of GF operations different than the first order.

Aspect 4: The method, apparatus, or non-transitory computer-readable medium of aspect 3, where each register in the set of registers is for storing a quantity of bits and the first order of GF operations and the second order of GF operations are less than or equal to the quantity.

Aspect 5: The method, apparatus, or non-transitory computer-readable medium of any of aspects 1 through 4, further including operations, features, circuitry, logic, means, or instructions, or any combination thereof for generating, based on performing one or more iterations of updating the set of values, a first sequence including a concatenation of first bits from values stored in the first register.

Aspect 6: The method, apparatus, or non-transitory computer-readable medium of aspect 5, further including operations, features, circuitry, logic, means, or instructions, or any combination thereof for outputting a second sequence including a concatenation of second bits from the values stored in the first register.

Aspect 7: The method, apparatus, or non-transitory computer-readable medium of aspect 6, where the first bits include least significant bits of the values stored in the first register during one or more iterations of updating the set of values and the second bits include most significant bits of the values stored in the first register during one or more iterations of updating the set of values.

Aspect 8: The method, apparatus, or non-transitory computer-readable medium of any of aspects 5 through 7, further including operations, features, circuitry, logic, means, or instructions, or any combination thereof for generating, based on generating the first sequence, a seed sequence that is based on the first sequence and performing, based on generating the seed sequence, a cryptographic operation using the seed sequence.

Aspect 9: The method, apparatus, or non-transitory computer-readable medium of any of aspects 5 through 8, further including operations, features, circuitry, logic, means, or instructions, or any combination thereof for generating, based on generating the first sequence, broad spectrum noise using the first sequence.

Aspect 10: The method, apparatus, or non-transitory computer-readable medium of any of aspects 5 through 9, where the first sequence includes a substantially random binary sequence.

Aspect 11: The method, apparatus, or non-transitory computer-readable medium of any of aspects 1 through 10, where storing second coefficient values in a second array of configuration registers, the second coefficient values indicating second GF multipliers; storing a second set of values in a second set of registers; and updating the second set of values stored in the second set of registers during a time interval that at least partially overlaps with updating the set of values stored in the set of registers, where updating the second set of values includes performing, according to the second GF multipliers indicated by the second coefficient values, a second set of GF multiplication operations on the second set of values stored in the second set of registers to generate a second set of multiplied values, performing a second GF summation operation on one or more of the second set of multiplied values to generate a second updated value, storing the second updated value in a second register in the second set of registers based on performing the second GF summation operation, and shifting the second set of values stored in the second set of registers from the second register to remaining registers in the second set of registers.

Aspect 12: The method, apparatus, or non-transitory computer-readable medium of any of aspects 1 through 11, where updating the set of values stored in the set of registers is based on a clock signal changing from a first value to a second value.

Aspect 13: The method, apparatus, or non-transitory computer-readable medium of any of aspects 1 through 12, where the set of registers are associated with a finite field generator.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
storing coefficient values in an array of configuration registers, the coefficient values indicating Galois Field multipliers;
storing a set of values in a set of registers based on storing the coefficient values; and
updating the set of values stored in the set of registers, the updating comprising:
performing, according to the Galois Field multipliers indicated by the coefficient values, a set of Galois Field multiplication operations on the set of values stored in the set of registers to generate a set of multiplied values,
performing a Galois Field summation operation on one or more of the set of multiplied values to generate an updated value,
storing the updated value in a first register in the set of registers based on performing the Galois Field summation operation, and
shifting the set of values stored in the set of registers from the first register to remaining registers in the set of registers.

2. The method of claim 1, further comprising:
storing, based on updating the set of values stored in the set of registers, second coefficient values in the array of configuration registers, wherein one or more of the second coefficient values are different than one or more of the coefficient values, and wherein the second coefficient values indicate second Galois Field multipliers; and
updating, based on storing the second coefficient values, the set of values stored in the set of registers according to the second Galois Field multipliers.

3. The method of claim 2, wherein:
the Galois Field multipliers are associated with a first order of Galois Field operations; and
the second Galois Field multipliers are associated with a second order of Galois Field operations different than the first order.

4. The method of claim 3, wherein:
each register in the set of registers is for storing a quantity of bits; and
the first order of Galois Field operations and the second order of Galois Field operations are less than or equal to the quantity.

5. The method of claim 1, further comprising:
generating, based on performing one or more iterations of updating the set of values, a first sequence comprising a concatenation of first bits from values stored in the first register.

6. The method of claim 5, further comprising:
outputting a second sequence comprising a concatenation of second bits from the values stored in the first register.

7. The method of claim 6, wherein:
the first bits comprise least significant bits of the values stored in the first register during one or more iterations of updating the set of values; and
the second bits comprise most significant bits of the values stored in the first register during one or more iterations of updating the set of values.

8. The method of claim 5, further comprising:
generating, based on generating the first sequence, a seed sequence that is based on the first sequence; and
performing, based on generating the seed sequence, a cryptographic operation using the seed sequence.

9. The method of claim 5, further comprising:
generating, based on generating the first sequence, broad spectrum noise using the first sequence.

10. The method of claim 5, wherein the first sequence comprises a substantially random binary sequence.

11. The method of claim 1, wherein:
storing second coefficient values in a second array of configuration registers, the second coefficient values indicating second Galois Field multipliers;
storing a second set of values in a second set of registers; and
updating the second set of values stored in the second set of registers during a time interval that at least partially overlaps with updating the set of values stored in the set of registers, wherein updating the second set of values comprises:
performing, according to the second Galois Field multipliers indicated by the second coefficient values, a second set of Galois Field multiplication operations on the second set of values stored in the second set of registers to generate a second set of multiplied values,
performing a second Galois Field summation operation on one or more of the second set of multiplied values to generate a second updated value,
storing the second updated value in a second register in the second set of registers based on performing the second Galois Field summation operation, and
shifting the second set of values stored in the second set of registers from the second register to remaining registers in the second set of registers.

12. The method of claim 1, wherein updating the set of values stored in the set of registers is based on a clock signal changing from a first value to a second value.

13. The method of claim 1, wherein the set of registers are associated with a finite field generator.

14. An apparatus, comprising:
an array of configuration registers configured to store coefficient values indicating Galois Field multipliers;
a set of registers coupled with the array of configuration registers and configured to store a set of values; and
a controller coupled with array of configuration registers and the set of registers, the controller configured to update the set of values stored in the set of registers, wherein to update the set of values, the controller is further configured to:
perform, according to the Galois Field multipliers indicated by the coefficient values, a set of Galois Field multiplication operations on the set of values stored in the set of registers to generate a set of multiplied values,
perform a Galois Field summation operation on one or more of the set of multiplied values to generate an updated value,
store the updated value in a first register in the set of registers based on performing the Galois Field summation operation, and
shift the set of values stored in the set of registers from the first register to remaining registers in the set of registers.

15. The apparatus of claim 14, wherein the controller is further configured to cause the apparatus to:
store, based on updating the set of values stored in the set of registers, second coefficient values in the array of configuration registers, wherein one or more of the second coefficient values are different than one or more of the coefficient values, and wherein the second coefficient values indicate second Galois Field multipliers; and
update, based on storing the second coefficient values, the set of values stored in the set of registers according to the second Galois Field multipliers.

16. The apparatus of claim 15, wherein:
the Galois Field multipliers are associated with a first order of Galois Field operations; and
the second Galois Field multipliers are associated with a second order of Galois Field operations different than the first order.

17. The apparatus of claim 14, wherein the controller is further configured to cause the apparatus to:
generate, based on performing one or more iterations of updating the set of values, a first sequence comprising a concatenation of first bits from values stored in the first register.

18. The apparatus of claim 17, wherein the controller is further configured to cause the apparatus to:
output a second sequence comprising a concatenation of second bits from the values stored in the first register.

19. The apparatus of claim 18, wherein:
the first bits comprise least significant bits of the values stored in the first register during one or more iterations of updating the set of values; and
the second bits comprise most significant bits of the values stored in the first register during one or more iterations of updating the set of values.

20. The apparatus of claim 17, wherein the first sequence comprises a substantially random binary sequence.

21. The apparatus of claim 14, wherein the controller is further configured to cause the apparatus to:
store second coefficient values in a second array of configuration registers, the second coefficient values indicating second Galois Field multipliers;
store a second set of values in a second set of registers; and
update the second set of values stored in the second set of registers during a time interval that at least partially overlaps with updating the set of values stored in the set of registers, wherein to update the second set of value, the controller is further configured to cause the apparatus to:
perform, according to the second Galois Field multipliers indicated by the second coefficient values, a second set of Galois Field multiplication operations on the second set of values stored in the second set of registers to generate a second set of multiplied values,
perform a second Galois Field summation operation on one or more of the second set of multiplied values to generate a second updated value,
store the second updated value in a second register in the second set of registers based on performing the second Galois Field summation operation, and
shift the second set of values stored in the second set of registers from the second register to remaining registers in the second set of registers.

22. A non-transitory computer-readable medium storing code, the code comprising instructions executable by a processor to:
store coefficient values in an array of configuration registers, the coefficient values indicating Galois Field multipliers;
store a set of values in a set of registers based on storing the coefficient values; and
update the set of values stored in the set of registers, wherein the instructions to update the set of values are executable by the processor to:
perform, according to the Galois Field multipliers indicated by the coefficient values, a set of Galois Field multiplication operations on the set of values stored in the set of registers to generate a set of multiplied values,
perform a Galois Field summation operation on one or more of the set of multiplied values to generate an updated value,
store the updated value in a first register in the set of registers based on performing the Galois Field summation operation, and
shift the set of values stored in the set of registers from the first register to remaining registers in the set of registers.

23. The non-transitory computer-readable medium of claim 22, wherein the instructions are further executable by the processor to:
store, based on updating the set of values stored in the set of registers, second coefficient values in the array of configuration registers, wherein one or more of the second coefficient values are different than one or more of the coefficient values, and wherein the second coefficient values indicate second Galois Field multipliers; and
update, based on storing the second coefficient values, the set of values stored in the set of registers according to the second Galois Field multipliers.

24. The non-transitory computer-readable medium of claim 23, wherein:
the Galois Field multipliers are associated with a first order of Galois Field operations; and
the second Galois Field multipliers are associated with a second order of Galois Field operations different than the first order.

25. The non-transitory computer-readable medium of claim 22, wherein the instructions are further executable by the processor to:
generate, based on performing one or more iterations of updating the set of values, a first sequence comprising a concatenation of first bits from values stored in the first register.
